(19) United States
(12) Patent Application Publication
(10) Pub. No.: US 2025/0274344 A1
(43) Pub. Date: Aug. 28, 2025

(54) BACKUP METHOD FOR NETWORK DEVICES CONNECTED TO A NETWORK, AND NETWORK DEVICE DESIGNED FOR THIS PURPOSE

(71) Applicant: PHOENIX CONTACT GMBH & CO.KG, Blomberg (DE)

(72) Inventors: Mike WATTENBERG, Leopoldshoehe (DE); Nicola KESSLER, Bielefeld (DE); Michael GERKE, Watstein (DE)

(21) Appl. No.: 19/115,315

(22) PCT Filed: Sep. 22, 2023
(86) PCT No.: PCT/EP2023/076207

§ 371 Date: Mar. 26, 2025

(30) Foreign Application Priority Data
Sep. 26, 2022 (DE) 10 2022 124 701.5

(51) Int. Cl. H04L 41/0853; H04L 41/12

(52) U.S. Cl. CPC H04L 41/0856; H04L 41/12

(57) ABSTRACT

The present disclosure relates to a backup method for network devices connected to a network and a network device designed for this purpose. In the method, network devices connected to a network are designed to use a protocol for neighborhood discovery and can transmit their own device information, in accordance with a network topology used for the network, to neighboring network devices connected to the network, and are designed to use the protocol for neighborhood discovery, and can receive device information, in accordance with the network topology, from neighboring network devices, designed to use the protocol for neighborhood discovery.

### FIELD

Embodiments of the present disclosure relates to a backup method for network devices connected to a network and a network device set up for this purpose.

### BACKGROUND

It is well known that, in a network topology, in particular a bus topology, in which a respective network device connected to a network in a neighboring manner to a network device connected as a subscriber to the network can be clearly identified as another subscriber, this is also referred to as neighborhood discovery. This requires a port (physical connection point) of a network device to which only one other network device is connected (point-to-point).

In Ethernet-based networks for industrial communication, the LLDP (Link Layer Discovery Protocol) is used for neighborhood discovery, for example. Using this topology discovery, a configuration that is stored in a control unit, also known in English as a “controller device,” can be reassigned after a device replacement, for example (see, e.g. ProfiNet). In addition to the controller unit, the system also requires unique identification, such as an ID, an order code or similar, whereby the respective device type or the respective network device class can be clearly identified.

### SUMMARY

In a network topology in which a respective network device connected to the network in a neighboring manner to a network device can be uniquely identified, the task of the present disclosure is to demonstrate an alternative way of retaining device information assigned to a network device, in particular type and/or configuration data, and in particular to make this information available again in the event of a network device being replaced.

According to the present disclosure, embodiments comprise a method and a network device having the features according to the independent claims, wherein the respective dependent claims each comprise preferred further embodiments. The present disclosure further discloses a computer program comprising program code tools for carrying out the method and by a computer-readable medium comprising instructions which, when executed on at least one computer, cause the at least one computer to carry out the steps of the method.

In particular, a network device is thus proposed which, using a protocol for neighborhood discovery, is set up, after connection to a network, for transmitting its own device information to network devices connected in a neighboring manner to the network, in accordance with a network topology used for the network, and set up to use the protocol for neighborhood discovery, and for receiving device information from network devices connected in a neighboring manner to the network, in accordance with the network topology, and set up to use the protocol for neighborhood discovery. According to an embodiment, this network device is now furthermore set up, after being connected to the network and after receiving device information from a network device connected in a neighboring manner to the network, to store this information assigned to this network device and to request its own device information from another network device connected in a neighboring manner to the network.

In particular, a backup method is thus further proposed for network devices connected to a network and set up to use a for neighborhood discovery protocol, wherein each of these network devices connected to the network and set up to use this protocol being set up, using this protocol, to send its own device information to network devices connected in a neighboring manner to the network, in accordance with a network topology used for the network, and set up to use the neighborhood discovery protocol, and to receive device information from network devices connected in a neighboring manner to the network, in accordance with the network topology, and set up to use the neighborhood discovery protocol, wherein, after two network devices, which are connected in a neighboring manner to one another and set up to use the protocol for neighborhood discovery have been switched on, at least a first of these two network devices with its own first device information transmits this first device information to the second of these two network devices and this first device information is stored there assigned to the transmitting network device, wherein, in the event of the first network device being replaced by a replacement network device and after this replacement network device has been switched on, it requests the transmission of the stored first device information from the second network device.

In another embodiment, after switching on two neighboring network devices which are designed to use the protocol for neighborhood discovery, at least a first of the two network devices, having its own first device information, transmits the first device information to the second of the two network devices and the information is stored there in a manner associated with the transmitting network device, wherein, if the first network device is replaced with a replacement network device, after the replacement network device is switched on, it requests, from the second network device, the transmission of the stored first device information.

An advantage according to an embodiment of the present disclosure is, that a network device is assigned as a “controller” or “supervisor” for at least one network device connected in a neighboring manner to the network, so after a network device replacement, the device information previously assigned to the replaced network device, in particular relating to a specific configuration, can also be restored for the replacement device in the simplest possible way, in particular in a decentralized manner.

The procedure according to the present embodiment can be implemented purely in software or purely in hardware or also by a combination of suitable hardware and software. In addition, or alternatively, a separate functional unit can be provided within the network device for the procedure according to the embodiments of the present disclosure. Accordingly. the installation, according to an embodiment, comprises a network device suitable for this purpose, which is implemented purely in software or purely in hardware or can also be provided by a combination of suitable hardware and software and, additionally or alternatively, a separate functional unit can be provided within the network device for the installation according to embodiments of the present disclosure of a network device suitable for this purpose. For example, a separate functional unit can also run as software on hardware already present in the network device, for example, an existing processor. However, hardware can also be provided specifically for a separate functional unit.

Furthermore, an embodiment of the present disclosure thus also relates in particular to a computer program comprising program code tools for carrying out the steps of the method. Finally, an embodiment of the present disclosure also relates in particular to a computer-readable medium comprising instructions which, when executed on at least one computer, cause the at least one computer to carry out the steps of the method. Such a medium may also be, for example, a CD-ROM or DVD or a USB or flash memory. It should also be noted that a computer-readable medium is not to be understood exclusively as a physical medium, but may also be present, for example, in the form of a data stream and/or a signal representing a data stream.

The present disclosure is suitable for a network topology based on daisy-chain (point-to-point, P2P) wiring, in which each network device has at least one unique neighbor. From the perspective of a network device, a direct neighbor is thus able to record the device information of this network device, in particular including its configuration data set, as an “unknown” data set and thus store it decentrally. Such a direct neighbor can therefore act as an assigned “controller” or “supervisor” for this network device. Furthermore, in the event of a device replacement, especially in the initialization phase, a replacement network device can ask its neighbor(s) for such device information stored there, in particular including a configuration contained therein.

### BRIEF DESCRIPTION OF THE DRAWINGS

Further advantages, features and possible applications of the present disclosure will become apparent from the following description of embodiments thereof and shown in the figures. The figures are schematic representations wherein:

FIG. 1 shows a highly simplified representation of a connection of network devices corresponding to a network topology used for a network within the scope of the present disclosure; and

FIG. 2 shows a very simplified representation of the connection of network devices as shown in FIG. 1, whereby however one network device has been replaced.

A detailed description of embodiments within the scope of the present disclosure is given below with reference to the drawings.

### DETAILED DESCRIPTION

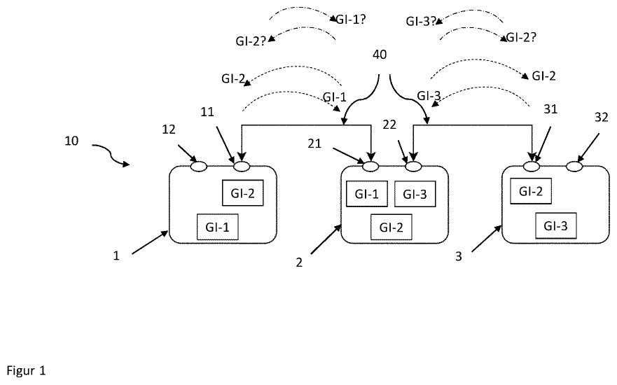

FIG. 1 shows highly simplified, a preferred connection of three network devices 1, 2 and 3, which are connected to a network 10, not shown further, in accordance with a network topology used for this network within the scope of the disclosure. For the communication connection 40 between the individual network devices 1, 2 and 3, a bus, in particular a 2-wire bus, but also a bus comprising more than just 2 wires or cores, can be used.

FIG. 1 only shows a possible, basic structure. In the example shown, each network device 1, 2 and 3, i.e. in particular each bus subscriber, has two connection ports, to each of which a further network device can be connected. With the first network device 1, a first connection port and a second connection port are labeled 11 and 12 respectively. Correspondingly, a first connection port and a second connection port on the second network device 2 are labeled 21 and 22 respectively and on the third network device 3 31 and 32 respectively. Alternatively, however, one or more network devices can have more than just two connection ports. The network device 2 is therefore arranged between the network devices 1 and 3 and is therefore connected in neighboring manner to both, or the network device 1 and the network device 3 are each connected in neighboring manner to the network device 2.

In the case of a bus as a communication connection 40, any protocol is suitable that allows at least two or more network devices as subscribers. Examples of this are RS485, RS422, LIN or similar.

Furthermore, in the example shown, each of these network devices 1, 2 and 3 is preferably set up to use a protocol for neighborhood discovery and, after connection to the network 10, as indicated by the dashed arrows, to transmit its own device information GI-1, GI-2 or GI-3 to network devices connected in accordance with the network topology used for the network in neighboring manner to the network and likewise set up to use the protocol for neighborhood discovery. Accordingly, each of these network devices 1, 2 and 3 can thus also preferably receive device information GI-2, GI-1 and GI-3 or GI-2 from network devices connected in accordance with the network topology used for the network in neighboring manner to the network and set up to use the protocol for neighborhood discovery. As described at the beginning, such protocols for neighborhood discovery are generally known. These protocols for neighborhood discovery can therefore be a manufacturer-independent, i.e., any Layer 2 protocol, such as the Link Layer Discovery Protocol, or LLDP for short.

Furthermore, within the scope of the present disclosure, each of these network devices 1, 2 and 3 is also preferably set up, on the one hand, after the respective connection to the network and after receiving device information from a network device connected in neighboring manner to the network, to also store this received device information assigned to this network device and, on the other hand, to request its own device information from another network device connected in neighboring manner to the network.

According to FIG. 1, the network device 2 is therefore appropriately set up to store the device information GI-1 from the network device 1 and also the device information GI-3 from the network device 3, or the network devices 1 and 3 can therefore each store the device information GI-2 from the network device 2 in a corresponding manner. On the other hand, as indicated by the dash-dotted arrows in FIG. 1, network device 2 could in principle also request its own device information from network device 1 and/or network device 3 again at any time, or network devices 1 and 3 could each request their own device information from network device 2 again in a corresponding manner. This therefore also leads to an overall reduction in risk in the network as a whole, because in particular in the event that, for whatever reason, information is lost in one of the network devices, “lost” device information can be easily requested again from a respective neighboring network device. For such a request, application-specific provision can be made, for example, for it to be initiated automatically or only after separate initialization.

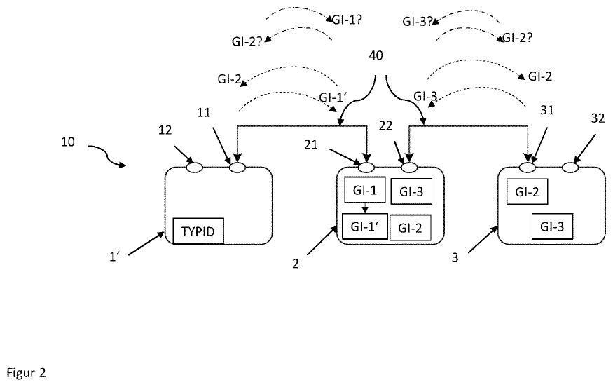

In particular, for reasons of a safe assignment between network device and device information, especially in the case of a device replacement, each of these device information items contains a data record specifying the respective network device from which such device information originates or has been transmitted, in particular a data record relating to the network device type. Based on this, each of these network devices 1, 2, 3 can then be appropriately set up or be able to compare this network device-specifying data record of a requested device information with a data record specifying the requesting network device, i.e., in particular a data set TYPID (cf. FIG. 2) already stored in this data set and relating to the network device type, for identity, whereby the TYPID contains a unique identification, such as an ID, an order code or similar, whereby the device type can be uniquely identified and the network device is therefore specified.

In particular, it is provided such a comparison for identity is carried out by the network device from which the device information is requested or by the network device that requests the device information, depending on the application or corresponding setup of the network devices. If the comparing network device is not the requesting network device, the requested device information can then be sent to the requesting network device if the compared data set is identical. If the comparing network device is the requesting network device and has therefore already received the requested device information for the comparison, the requested device information can be stored again at the requesting network device if the compared data set is identical.

Consequently, in particular with the network devices 1, 2 3 suitably set up above, a backup procedure, and thus in particular a decentralized backup procedure of device information according to the present disclosure, can be carried out.

If, for example, the network devices 1, 2 and 3 set up to use a protocol for neighborhood discovery are connected to the network 10, as described above with reference to the embodiment example according to FIG. 1, each can, on the one hand, transmit its own device information GI-1. GI-2 or GI-3 to the network devices connected in neighboring manner to the network in accordance with the network topology used for the network and likewise set up to use the protocol for neighborhood discovery and, on the other hand, also receive the device information from the other network devices connected adjacent to the network in accordance with the network topology. Thus, according to the backup method according to the present disclosure, after two neighboring network devices, such as network device 1 and network device 2, which are set up to use the protocol for neighborhood discovery, have been switched on, at least a first of these two network devices with its own, first device information, e.g. network device 1 with its own first device information GI-1, is transmitting this first device information to the second of these two network devices, i.e., according to the underlying example to, e.g., network device 2, and stored there assigned to the transmitting network device, i.e., according to the underlying example stored in the network device 2 assigned to the sending network device 1 according to the underlying example, and then if the first network device, i.e., network device 1 according to the underlying example, is replaced by a replacement network device 1′ (see FIG. 2) and after this replacement network device 1′is switched on, it can request the transmission of the first device information stored from the second network device, i.e., the device information GI-1 at network device 2 according to the underlying example.

In particular, an identifier of a connection port via which the device information has been received can also be included for the assignment between the network device that transmits the device information and precisely this transmitted device information when it is stored in the received network device. If, for example, as shown in FIG. 1, the network device 1 is connected to or via the first connection port 21 of the second network device 2, the network device 2 consequently only receives device information from the network device 1 via this connection port 21. If the network device 1 is now replaced by a replacement network device 1′ (see FIG. 2), the replacement network device 1′is consequently again connected to or via the first connection port 21 of the second network device 2. If the replacement network device 1′ now requests the transmission of stored device information from the second network device 2, cf. the dot-dashed arrow marked GI-1? in FIG. 2, this request is also transmitted via the same connection port as the device information GI-1 previously received from the replaced network device 1. Consequently, the connection port can also be used to make a clear assignment between the network device transmitting device information and precisely this transmitted device information when it is stored in the received network device, and even in the case of a request for stored device information via the same connection port, it is clear that the requested device information is the device information previously received via this connection port. without this having to be explicitly included in the request.

As described above, the request for the first device information from the second network device can also be initiated automatically or only after separate initialization by the replacement network device, in particular depending on the existing or specified application.

If, as already described above with regard to embodiments of the network devices, each of these device information items also contains a data record specifying a network device, in particular a data record relating to the network device type, this data record is preferably first compared for identity with a data record specifying the replacement network device, in particular relating to the network device type, in particular the data record TYPID held therein, after the first device information item has been requested from the second network device by the replacement network device, and the first device information item is only stored in the replacement network device if it is identical. In particular, if the data set specifying the replacement network device is also transmitted as part of the request, the comparison can therefore also be performed by the network device which is not the requesting network device.

If there is no identity, the replacement network device's own device information is updated appropriately, for example according to the state of the art described at the beginning by means of information stored in a (central) control unit, in particular relating to a specific configuration, and the updated device information, labeled GI-1′ in FIG. 2, is then sent to neighboring network devices, and thus in particular also to the second network device, e.g., network device 2 according to FIGS. 1 and 2, and stored there.

In particular, however, in the event of an update of the own device information, it is intended that this is transmitted by the respective network device to at least one network device connected in neighboring manner to it, in particular to each network device connected in neighboring manner to it, and stored there, assigned to the respective transmitting network device. The previously stored device information assigned to the previously replaced neighboring network device is conveniently deleted. With reference to FIG. 2, the device information GI-1′ would therefore be newly stored in the network device 2 and the device information GI-1 assigned to the previously replaced neighboring network device 1 would be conveniently deleted, i.e. the device information GI-1 would be replaced by the device information GI-1′, conveniently in a memory area provided for this purpose.

Consequently, in particular within the scope of the present disclosure, when updating own device information, a data record, in particular a configuration data record, assigned to the respective network device in an application-specific manner can be stored for the first time in the device information or such a data record, i.e., in particular a configuration data record, assigned to the respective network device in an application-specific manner and stored in the device information can be updated.

With the background of FIGS. 1 and 2, within the context of a backup method according to the present disclosure of course additionally or alternatively, the network device designated as network device 2 in FIG. 1 can also act as first network device and the network device designated as network device 1 in FIG. 1 can also act as the second network device, additionally or alternatively the network device designated as network device 2 in FIG. 1 can also act as the first network device and the network device designated as network device 3 in FIG. 1 can also act as the second network device, additionally or alternatively the network device designated as network device 2 in FIG. 1 can also act as the first network device and the network device designated as network device 3 in FIG. 1 can also act as the second network device, additionally or alternatively, the network device designated as network device 3 in FIG. 1 can also act as the first network device and the network device designated as network device 2 in FIG. 1 can also act as the second network device.

Returning once again to the example according to FIG. 1, the network 10 thus consists, for example, of a “chain” of three network devices 1, 2 and 3. At a time t, these can each have their own device information with an individual data set, such as an individual configuration. After a respective setting, i.e., updating of a respective own device information GI-1, GI-2, GI-3, i.e. in particular a respective individual data set, for one or more of the network devices 1, 2, 3, this respective device information is also transmitted to at least one of the network devices connected in neighboring manner to it and stored there, suitably in a memory area reserved for this purpose.

For example, immediately after setting the device information GI-2 for the network device 2, this device information GI-2 is transmitted to the network devices 1 and/or 3 and stored there, i.e., expediently in a memory area reserved for this purpose.

The network 10 shown in FIG. 1 can therefore be set up in the form of daisy-chain (point-to-point) wiring, so each network device 1, 2 and 3 has at least one unique neighboring network device. From the perspective of a network device, the direct neighboring network device is therefore able to receive the configuration as an “unknown” data set.

In the event of a device replacement, the replacement network device can therefore ask at least one neighboring network device for device information previously stored there in relation to the replaced network device, in particular including a configuration contained therein, or request this device information from the neighboring network device, particularly during the initialization phase. For safety reasons in particular, for example to avoid configuration conflicts, the device information should also be unique for the replacement network device. The device information should therefore also contain a data record specifying the network device, in particular a TYPID data record relating to the network device type, i.e. a unique identification of the respective device type, such as an ID, an order code or similar

This means the neighboring network devices can hold or decentrally store device information that is unknown to them but assigned to the directly neighboring network device.

For example, with reference to FIG. 1, the following constellations of decentrally stored device information can result in a running, configured network:

| In the | via | Device | Device | Device |
|---|---|---|---|---|
| network | connection | infor- | information | information |
| device | port | mation | TYPID | Configuration- |
| 1 | 2 | EMPTY | EMPTY | EMPTY |
| | | (no | | |
| | | neighbor) | | |
| 1 | 11 | GI-2 | TYPE-Network | Configuration- |
| | | | device 2 | Network device |
| | | | | 2 |
| 2 | 21 | GI-1 | TYPE-Network | Configuration- |
| | | | device 1 | Network device |
| | | | | 1 |
| 2 | 22 | GI-3 | TYPE-Network | Configuration- |
| | | | device 3 | Network device |
| | | | | 3 |
| 3 | 31 | GI-2 | TYPE-Network | Configuration- |
| | | | device 2 | Network device |
| | | | | 2 |
| 3 | 32 | EMPTY | EMPTY | EMPTY |
| | | (no | | |
| | | neighbor) | | |

If, in a possible application scenario, such as a network device failure, e.g., a failure of network device 2, the failed network device 2 is now replaced by a “new” replacement network device of the same type TYPID, this “new” replacement network device of the same type could now ask its neighboring network devices, e.g., network devices 1 and 3, for corresponding device information during a startup phase. If the device information is also valid for the “new” replacement network device, the device information can be transferred to the “new” replacement network device if required, so that the “new” replacement network device can make any necessary settings. This can be advantageous for configuration data, for example.

However, if in the possible application scenario, such as the failure of network device 2, the failed network device 2 is now replaced by a “new” replacement network device of a different or other TYPID type, and the “new” replacement network device now asks its neighboring network devices for the corresponding device information during the startup phase, it would be possible to determine that the decentrally stored device information is not valid for the “new” replacement network device. The device information GI-2 previously stored for network device 2 in the neighboring network device can therefore be deleted. In particular, however, after setting, i.e., updating, the device information for the “new” replacement network device, this device information can in turn be stored in each neighboring network device

Of course, other and/or further data record types contained in a respective device information are also possible within the scope of the present disclosure.

If another network device is connected to a free connection of a network device, such as the connection port 32 of network device 3, the transmission of the respective device information between the network devices connected next to each other can also take place during operation.

It is therefore generally extremely important, especially at the start of an initialization phase, that each network device, in particular bus subscribers, can determine its function and position within the network, in particular according to the network topology used, e.g. along a “chain”. Based on a possible start sequence of network device 2, this can be realized as follows, for example.

After network device 2 is switched on, it waits for incoming device information from network device 1 and/or 3.

If network device 1 and/or network device 3 sends or send the device information GI-1 or G-3 to network device 2, this “neighbor” device information is stored in network device 2 and thus saved there. If no device information is received via a connection port, no neighbor network device is connected there.

Accordingly, network device 2 transmits its own device information GI-2 to all neighboring connected network devices 1, 3 or, if necessary, this own device information GI-2 can also be restored, so that, in particular in the case that network device 2 is a replacement network device, for example, a configuration assigned to the previously replaced network device can be made available again for network device 2 by neighboring network device 1 and/or neighboring network device 3. As a result, each network device knows its function and position.

It can be seen from the above description that, in particular, the method according to embodiments of the present disclosure can be implemented purely in software or purely in hardware or can also be provided by a combination of suitable hardware and software. A separate functional unit within the network device can also be provided for the method according to embodiments of the disclosure. Accordingly, the installation according to embodiments of the present disclosure of a network device suitable for this purpose can also be implemented purely in software or purely in hardware or can also be provided by a combination of suitable hardware and software and, additionally or alternatively, a separate functional unit can be provided within the network device for the installation according to embodiments of the disclosure of a network device suitable for this purpose.

For example, a separate functional unit can also run as software on hardware already present in the network device, for example an existing processor. However, hardware can also be provided specifically for a separate functional unit. A computer program can also be provided for the procedure, the separate functional unit and/or for the installation according to embodiments of the present disclosure, which comprises program code tools for carrying out the steps of the method according to embodiments of the present disclosure. Likewise, a computer-readable medium, e.g., a CD-ROM or DVD or a USB or flash memory, can also be used for this purpose, which comprises instructions which, when executed on at least one computer, cause the at least one computer to perform the steps of the method according to embodiments of the present disclosure. However, such a computer-readable medium need not be exclusively a physical medium, but may, for example, also be in the form of a data stream and/or a signal representing a data stream.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present disclosure requires more features.

Moreover, though the description of the present disclosure has included description of one or more embodiments, configurations, or aspects and certain variations and modifications, other variations, combinations, and modifications are within the scope of the present disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges or steps to those described in the description, whether or not such alternate, interchangeable and/or equivalent structures, functions, ranges or steps are disclosed herein, and without intending to publicly dedicate any patentable subject matter.

1. A backup method for network devices connected to a network and designed to use a neighborhood discovery protocol, wherein each of said network devices connected to the network and designed to use said protocol is designed to use said protocol to send its own device information, according to a network topology used for the network, to neighboring network devices connected to the network and set up to use the neighborhood discovery protocol, and to receive device information from neighboring network devices connected- to the network and set up to use the neighbor discovery protocol according to the network topology,
wherein:
after switching on two neighboring network devices which are designed to use the protocol for neighborhood discovery, at least a first of these two network devices with its own first device information transmits this first device information to the second of these two network devices and said information is stored there in a manner associated with the transmitting network device, wherein, if the first network device is replaced by a replacement network device, the transmission of the stored first device information is requested from the second network device after this replacement network device has been switched on.

2. The backup method according to claim 1, wherein a manufacturer-independent layer 2 protocol is used as the protocol for neighborhood discovery in order to exchange information relating to the respective device, in particular comprising device names and/or IP addresses for device identification, between devices connected to the network in a neighboring manner and set up to use the protocol for neighborhood discovery.

3. The backup method according to claim 1, wherein the request for the first device information at the second network device is initiated automatically by the replacement network device or only after separate initialization.

4. The backup method according to claim 1, wherein each of said device information comprises a data set specifying a network device, which data set, after requesting the first device information at the second network device by the replacement network device, is compared for identity with a data set specifying the replacement network device, in particular held in the replacement network device, wherein in case of identity the first device information is stored in the replacement network device.

5. The backup method according to claim 4, wherein if the identity does not exist, the replacement network device's own device information is updated and this updated device information is sent to the second network device and stored there.

6. The backup method according to claim 1,
wherein, in the case of an update of own device information, this information is in each case transmitted by the respective network device to at least one network device connected in a neighboring manner to it, in particular to each network device connected in a neighboring manner to it, and is stored there, assigned to the respective transmitting network device; and/or
wherein, when updating own device information, a data set, in particular a configuration data set, assigned to the respective network device in an application-specific manner is stored for the first time in the device information or the data set stored in the device information and assigned to the respective network device in an application-specific manner is updated.

7. A network device, which is set up using a neighborhood discovery protocol, after being connected to a network, for transmitting its own device information to network devices connected in a neighboring manner to the network, in accordance with a network topology used for the network, and set up to use the neighborhood discovery protocol and for receiving device information from network devices connected in a neighboring manner to the network, in accordance with the network topology used for the network, and set up to use the protocol for neighborhood discovery protocol,
and which is furthermore set up, after connection to the network and after receiving device information from a network device connected in a neighboring manner to the network, to store this information assigned to this network device and to request its own device information from another network device connected in a neighboring manner to the network.

8. The network device according to claim 7, wherein each of said device information contains a data set specifying a network device, and the network device is further designed to compare said data set of a requested device information with a data set specifying the requesting network device, in particular held in the latter, for identity, and, if the identity is determined, to send the requested device information to the requesting network device if the network device is not the requesting network device, or to store the requested device information if the network device is the requesting network device.

9. A computer program comprising program code tools for carrying out the method according to claim 1.

10. A computer readable medium comprising instructions which, when executed on at least one computer, cause the at least one computer to perform the steps of the method according to claim 1.
